(19) United States
(12) Patent Application Publication
(10) Pub. No.: US 2012/0099401 A1
(43) Pub. Date: Apr. 26, 2012

(54) SENSOR AND SENSING METHOD

(75) Inventor: Kaoru Yamashita, Kyoto (JP)

(73) Assignee: National University Corporation Kyoto Institute of Technology, Kyoto (JP)

(21) Appl. No.: 13/381,153

(22) PCT Filed: Jun. 1, 2010
(86) PCT No.: PCT/JP2010/059236

§ 371 Date: Dec. 28, 2011

(30) Foreign Application Priority Data
Jul. 3, 2009 (JP) 2009-158329

(51) Int. Cl. G01S 3/80

(52) U.S. Cl. 367/118

(57) ABSTRACT

A sensor and sensing method are provided in which a ghost which significantly occurs when only higher frequencies are present can be reduced, and a high directivity which is not obtained when only lower frequencies are present can be obtained. A sensor 100 for detecting a direction of an object to be sensed (target), includes a sensing section 102 configured to sense wave motions having a plurality of frequencies which come from the target 2, an information acquisition section 106 configured to acquire information about incoming directions of the wave motions, and a determination section configured to determine the direction of the target 2. The sensing section 102 senses at least a first wave motion having a first one of the plurality of frequencies and a second wave motion having a second one of the plurality of frequencies. The information acquisition section 106 acquires first information about the incoming direction of the first wave motion and second information about the incoming direction of the second wave motion. The determination section 108 determines the direction of the target 2, based on at least the first information and the second information.

### TECHNICAL FIELD

The present invention relates to sensors for detecting a direction of an object to be sensed, and sensing methods for detecting a direction of an object to be sensed.

### BACKGROUND ART

Phased array sensing is a technique of measuring the angle of incidence based on the fact that “the phases of incoming waves are varied among positions of elements arranged in an array, depending on the incident angle.” For example, Patent Document 1 describes sensing which employs a piezoelectric diaphragm type sensor. The precision (angular resolution) of detection of the azimuth of an object to be sensed by an incident angle measurement technique intrinsically depends on the relationship between the diameter and inter-element spacing (more exactly, a pitch) of the array and the wavelength of an incoming wave used for detection of the azimuth of the object to be sensed.

Non-Patent Document 1 analyzes the angular resolution in a geometric manner. A grating lobe does not occur in a directional pattern corresponding to information about a low frequency wave motion. A narrow main lobe appears in a directional pattern corresponding to information about a high frequency wave motion, which indicates a high resolution.

### Citation List

### Patent Documents

Patent Document 1: Japanese Unexamined Patent Application Publication No. 2003-284182

### Non-Patent Documents

Non-Patent Document 1: Review of Progress in Quantitative Nondestructive Evaluation, vol. 17, Plenum Press, New York (1998) 883-890

### SUMMARY OF THE INVENTION

### Technical Problem

However, in order to achieve a phased array sensor which detects an angular direction with high precision, it is necessary to “increase the diameter of the array to increase the angular resolution” and “reduce the element pitch to prevent a grating lobe.” Therefore, a large number of elements is necessarily required. The presence of a grating lobe may cause a ghost.

Specifically, if there are a sufficiently large number of elements, the full width at half maximum of a main lobe is inversely proportional to the diameter of the array, and the angular resolution decreases with an increase in the array diameter. On the other hand, if the element pitch exceeds λ/(1+sin θ), a grating lobe may occur, where θ is a scan angle range (maximum scan angle) and λ is the wavelength of a detection wave.

If, for the sake of simplicity, it is assumed that the distance to a target object is sufficiently greater than the array diameter that an incident wave is assumed to be a plane wave, a relative sensitivity d(θ, φ) in the θ direction which is obtained when the sensor scans in the φ direction, may be represented by:

d(θ, φ)=cos (θ)|sinc (p)||sinn (N, q−r)|

where

a: element size

b: element pitch

α=a/λ

β=b/λ

sinc(p)=sin (p)/p

p=πα sin (θ)

sinn (N, q)=sin (Nq)/(Nsin (q))

q=πβ sin (θ)

r=πβ sin (φ)

FIG. 12(a) is a chart showing a directional pattern corresponding to information about a low frequency wave motion. The radial coordinate indicates relative sensitivities, and the angular coordinate indicates azimuths θ. In conventional sensors, a grating lobe does not occur in a directional pattern corresponding to information about a wave motion having a frequency lower than a predetermined value. On the other hand, a non-sharp main lobe appears in a directional pattern corresponding to information about a wave motion having a low frequency.

FIG. 12(b) is a chart showing a directional pattern corresponding to information about a high frequency wave motion. The radial coordinate indicates relative sensitivities, and the angular coordinate indicates azimuths θ. In conventional sensors, a sharp main lobe appears in a directional pattern corresponding to information about a wave motion having a high frequency. On the other hand, a grating lobe occurs in a directional pattern corresponding to information about a wave motion having a frequency higher than a predetermined value.

Note that, in a directional pattern, a main lobe and side lobes appear, depending on the frequency. Of the side lobes, one whose intensity is equal to or greater than that of the main lobe is defined as a grating lobe.

The present invention has been made in view of the above problems. It is an object of the present invention to provide a sensor and sensing method which employ phased array sensing and reduce a ghost based on a grating lobe which significantly occurs when only higher frequencies are present, and achieve a high directivity (high resolution) which is not obtained when only lower frequencies are present.

### Solution to the Problem

To solve the above problems, a sensor for detecting a direction of an object to be sensed, according to the present invention, includes a sensing section configured to sense wave motions having a plurality of frequencies which come from the object to be sensed, an information acquisition section configured to acquire information about incoming directions of the wave motions, and a determination section configured to determine the direction of the object to be sensed. The sensing section senses at least a first wave motion having a first one of the plurality of frequencies and a second wave motion having a second one of the plurality of frequencies. The information acquisition section acquires first information about the incoming direction of the first wave motion and second information about the incoming direction of the second wave motion. The determination section determines the direction of the object to be sensed, based on at least the first information and the second information.

As described in the BACKGROUND ART section, in conventional sensors, a sharp main lobe and a large grating lobe appear in a directional pattern corresponding to information about a high frequency wave motion. In a directional pattern corresponding to information about a low frequency wave motion, a grating lobe does not occur and a non-sharp main lobe appears (low resolution).

In this regard, according to the sensor of the present invention, at least the first wave motion having the first one of the plurality of frequencies and the second wave motion having the second one of the plurality of frequencies are sensed. The first information about the incoming direction of the first wave motion and the second information about the incoming direction of the second wave motion are obtained. The direction of the object to be sensed is determined based on at least the first information and the second information. Therefore, a sensor can be obtained in which a grating lobe which occurs significantly when only a single higher frequency is present can be reduced, and a sharp directivity (high resolution) which cannot be obtained when only a single lower frequency is present can be achieved.

Thus, according to the configuration of the sensor of the present invention, a single sensor is used to obtain a plurality of pieces of information, whereby an influence of a grating lobe can be eliminated without narrowing the inter-element spacing. Therefore, the number of elements for achieving the same angular resolution (i.e., for configuring an array having the same diameter) can be significantly reduced. In particular, in a three-dimensional measurement, if elements are arranged in two dimensions, the reduction effect can be improved by the square.

According to the configuration of the sensor of the present invention, a three-dimensional measurement free of a ghost can be achieved using a structure with a significantly reduced number of elements. Therefore, the present invention is applicable to medial diagnostic equipment (e.g., medical sonography equipment) and MEMS-related major parts (three-dimensional sensor) in the automobile field.

In the sensor of the present invention, the sensing section may select the first and second frequencies so that the information acquisition section acquires first false information and second false information different from the first false information. Here, the first false information indicates a direction different from the incoming direction of the first wave motion, and the second false information indicates a direction different from the incoming direction of the second wave motion. The first information includes first incoming direction information indicating the incoming direction of the first wave motion, and the first false information. The second information includes second incoming direction information indicating the incoming direction of the second wave motion, and the second false information. According to the configuration of the sensor of the present invention, the first false information is different from the second false information, and therefore, by determining the direction of the object to be sensed based on the first information and the second information, the occurrence of a grating lobe can be reliably reduced, whereby a ghost can be reduced.

In the sensor of the present invention, the determination section may determine the direction of the object to be sensed, based on at least one of the arithmetic product and minimum calculation of a value indicating the first information and a value indicating the second information. If the direction of the object to be sensed is determined based on at least one of the arithmetic product and minimum calculation, an influence of a grating lobe can be eliminated, whereby a ghost can be reduced. The arithmetic product and the minimum calculation can also be combined. Because the arithmetic product and the minimum calculation can be calculated using a simple calculation circuit, a simple and low-cost sensor structure can be constructed.

For example, if the first and second frequencies have been selected by previously performing geometric analysis so that information corresponding to a grating lobe is contained only in the second one of the first false information and the second false information, an influence of a grating lobe can be eliminated by performing at least one of the arithmetic product and the minimum calculation, whereby a ghost can be reliably reduced. In this case, the first frequency corresponds to a low frequency, and the second frequency corresponds to a high frequency.

In the sensor of the present invention, the plurality of frequencies may include a plurality of resonant frequencies possessed by the sensing section. The first frequency may correspond to a first one of the plurality of resonant frequencies. The second frequency may correspond to a second one of the plurality of resonant frequencies.

According to the configuration of the present invention, for example, the sensor element is assumed to be of resonant type in which resonance occurs in the sensor element at a plurality of specific frequencies. Because a single pulse used in measurement has a wide frequency spectrum, the resonance sensor receives such a pulse to oscillate at its own resonant frequency and output an output waveform corresponding to the resonant frequency. As a result, the sensor of the present invention can be obtained with a simple configuration without using a circuit for adjusting the frequency of a wave motion to be sensed by the sensing section, or a frequency filter.

The sensor of the present invention may further include a frequency adjuster configured to adjust a frequency of a wave motion to be sensed by the sensing section from the first frequency to the second frequency.

According to the configuration of the present invention, if a frequency suitable for efficient reduction of a ghost and a frequency for providing a highest resolution have been found out by previously performing geometric analysis, the frequency of a wave motion to be sensed by the sensing section can be arbitrarily set to those frequencies. As a result, a sensor can be obtained in which a ghost is reduced to a highest extent and a highest resolution is provided.

For example, if the first and second frequencies have been found out by previously performing geometric analysis so that information corresponding to a grating lobe is contained only in the second one of the first false information and the second false information, the frequency adjuster can adjust the frequency to be sensed by the sensing section to the first and second frequencies. In this case, the first frequency corresponds to a low frequency, and the second frequency corresponds to a high frequency.

To solve the above problems, a sensing method for detecting a direction of an object to be sensed, according to the present invention, includes a sensing step of sensing wave motions having a plurality of frequencies which come from the object to be sensed, an information acquisition step of acquiring information about incoming directions of the wave motions, and a determination step of determining the direction of the object to be sensed. The sensing step is performed by sensing at least a first wave motion having a first one of the plurality of frequencies and a second wave motion having a second one of the plurality of frequencies. The information acquisition step is performed by acquiring first information about the incoming direction of the first wave motion and second information about the incoming direction of the second wave motion. The determination step is performed by determining the direction of the object to be sensed, based on at least the first information and the second information.

According to the sensing method of the present invention, advantages similar to those of the sensor of the present invention described above are achieved. Specifically, the first wave motion having the first one of the plurality of frequencies and the second wave motion having the second one of the plurality of frequencies are sensed. The first information about the incoming direction of the first wave motion and the second information about the incoming direction of the second wave motion are obtained. The direction of the object to be sensed is determined based on at least the first information and the second information. Therefore, a sensor can be obtained in which a ghost based on a grating lobe which occurs significantly when only higher frequencies are present can be reduced, and a sharp directivity (high resolution) which cannot be obtained when only lower frequencies are present can be achieved.

### BRIEF DESCRIPTION OF THE DRAWINGS

FIG. 1 is a schematic diagram showing a configuration of a sensor according to a first embodiment of the present invention.

FIG. 2 is a cross-sectional view showing one of a plurality of sensing elements.

FIG. 3(a) is a diagram showing a response waveform corresponding to a wave motion based on an ultrasonic wave sensed by a first sensing element, and FIG. 3(b) is a diagram showing a spectrum of a response waveform which is obtained by the Fourier transform of the waveform of FIG. 3(a).

FIG. 4 is a schematic diagram showing an information acquisition section.

FIG. 5(a) is a chart showing a directional pattern corresponding to first information and a directional pattern corresponding to second information, and FIG. 5(b) is a chart showing a directional pattern corresponding to the arithmetic product of a value indicating the first information and a value indicating the second information.

FIG. 6 is a flowchart showing a sensing method using the sensor of the first embodiment of the present invention.

FIG. 7 is a schematic diagram showing a configuration of a sensor according to a second embodiment of the present invention.

FIG. 8 is a cross-sectional view showing one of a plurality of sensing elements.

FIG. 9 is a diagram showing a response waveform corresponding to a wave motion based on an ultrasonic wave sensed by a fifth sensing element.

FIG. 10 is a hysteresis diagram showing changes in a resonant frequency of the fifth sensing element with respect to voltages applied to an external electrode.

FIG. 11 is a flowchart showing a sensing method using the sensor of the second embodiment of the present invention.

FIG. 12(a) is a chart showing a directional pattern corresponding to information about a low frequency wave motion, and FIG. 12(b) is a chart showing a directional pattern corresponding to information about a high frequency wave motion.

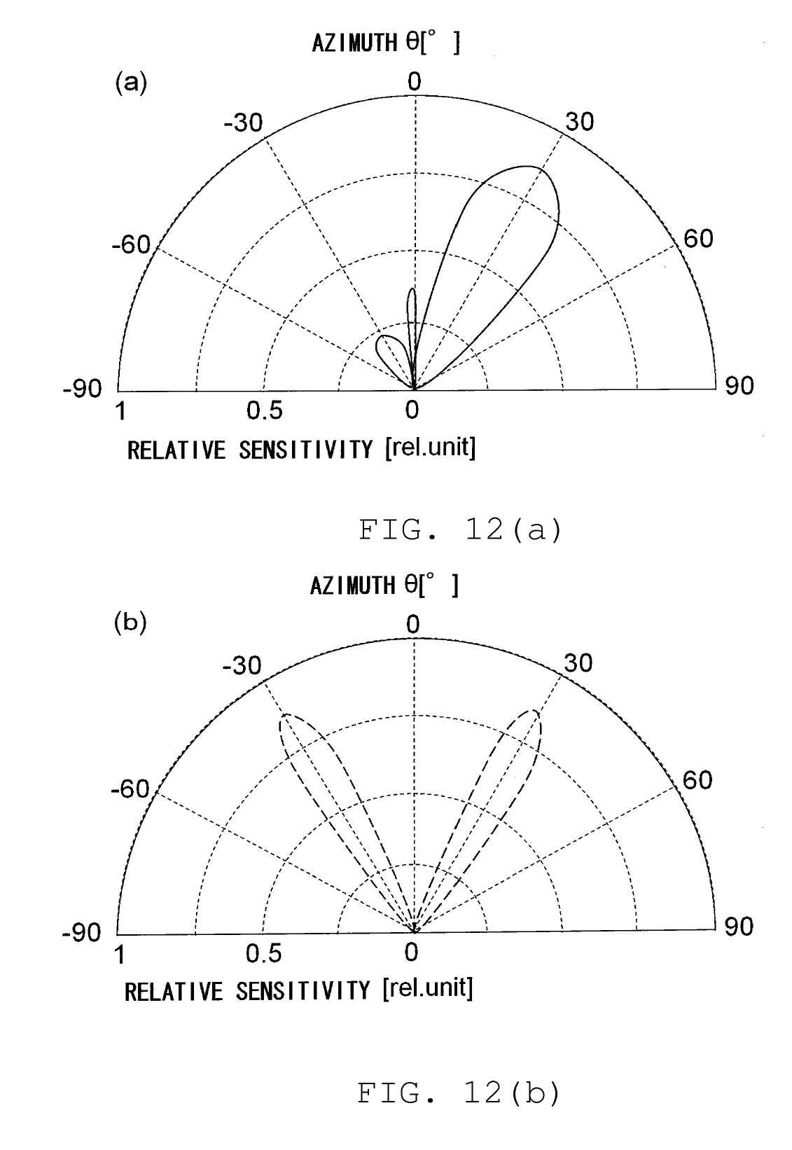

### DESCRIPTION OF EMBODIMENTS

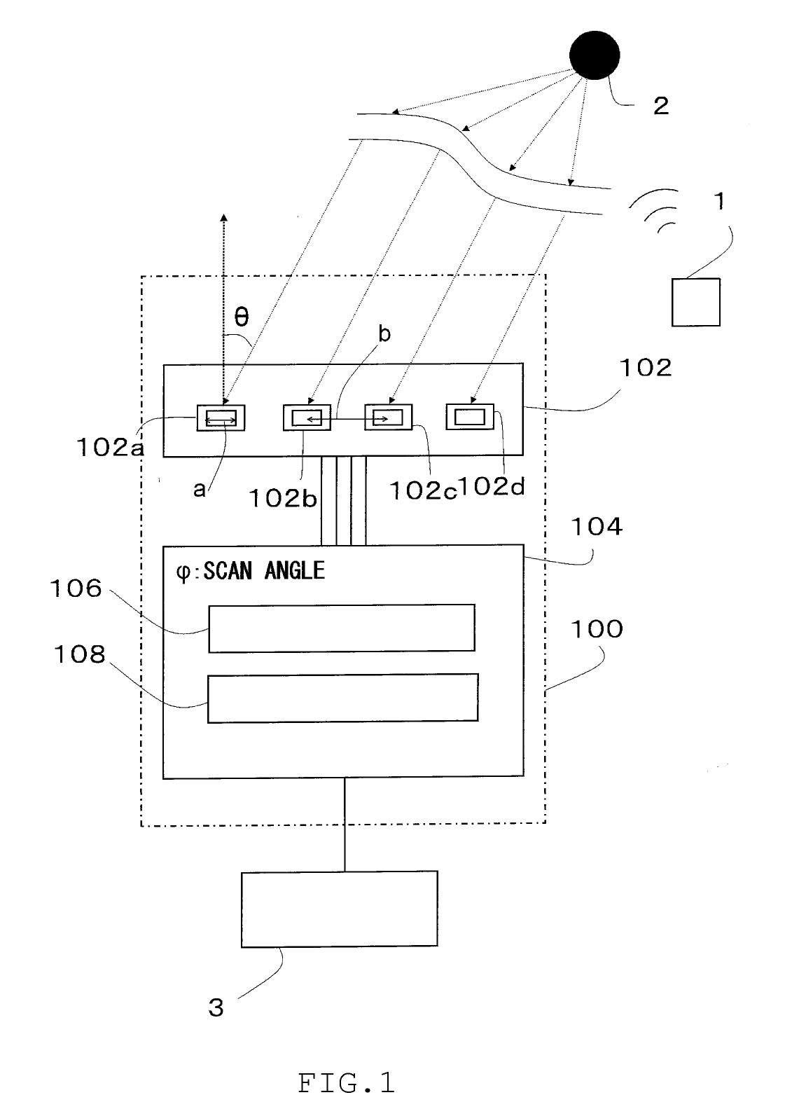

Embodiments relating to a sensor and sensing method of the present invention will be described with reference to FIGS. 1-11. The present invention is not intended to be limited to the embodiments described below or configurations shown in the drawings, and is intended to encompass configurations equivalent to those configurations.

### First Embodiment

FIG. 1 is a schematic diagram showing a configuration of a sensor 100 according to a first embodiment of the present invention. The sensor 100 detects the azimuth of an object to be sensed. An ultrasonic wave generated from an ultrasonic generator 1 which is an example wave motion generation source, reaches an object to be sensed (target 2) and is then reflected by the target 2. The ultrasonic wave reflected by the target 2 is incident to the sensor 100 at an angle θ relative to a direction perpendicular to a surface of the sensor 100 to which the ultrasonic wave is incident. The sensor 100 detects a direction of the target 2. A display section 3 displays the result of the detection.

The sensor 100 includes a sensing section 102 which senses ultrasonic waves having a plurality of frequencies which come from the target 2, and an information processor 104 which processes sensed information. For example, a unit circuit including a plurality of delay circuits and an addition circuits, or a CPU in a computer, functions as the information processor 104. The information processor 104 includes an information acquisition section 106 which acquires information about an incoming direction of the ultrasonic wave, and a determination section 108 which determines the direction of the target 2. The sensing section 102 includes a plurality of sensing elements (a first sensing element 102a, a second sensing element 102b, a third sensing element 102c, and a fourth sensing element 102d). Note that the number of the sensing elements may be arbitrarily changed. For example, a piezoelectric diaphragm microsensor functions as each of the sensing elements. In FIG. 1, a length of a diaphragm portion (a diameter of the array) is represented by a “length a,” and an element pitch (inter-element spacing) is represented by a “length b.”

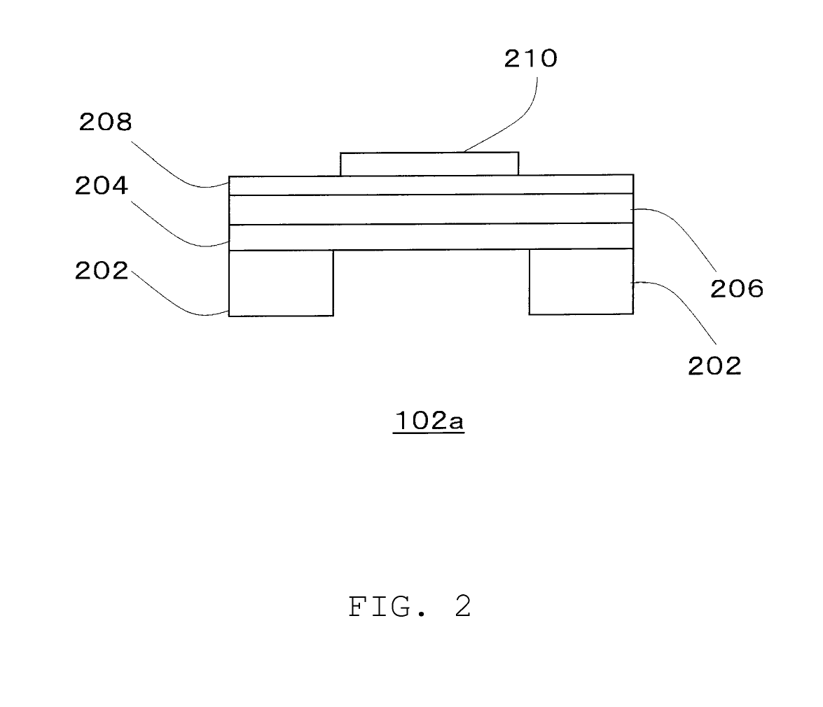

FIG. 2 is a cross-sectional view showing a piezoelectric diaphragm microsensor as an example of one (the first sensing element 102a) of the sensing elements. The first sensing element 102a includes a Si substrate 202, a SiO₂ layer 204, a lower electrode layer 206, a piezoelectric layer 208, and an upper electrode layer 210.

The lower electrode layer 206 contains Pt and Ti. For example, a Pt/Ti electrode functions as the lower electrode layer 206. The piezoelectric layer 208 contains lead zirconate titanate (Pb(Zr,Ti)O₃) (hereinafter referred to as “PZT”). For example, a PZT layer functions as the piezoelectric layer 208. The upper electrode layer 210 contains Au. For example, a Au electrode functions as the upper electrode layer 210. The second sensing element 102b, the third sensing element 102c, and the fourth sensing element 102d each have a configuration equivalent to that of the first sensing element 102a.

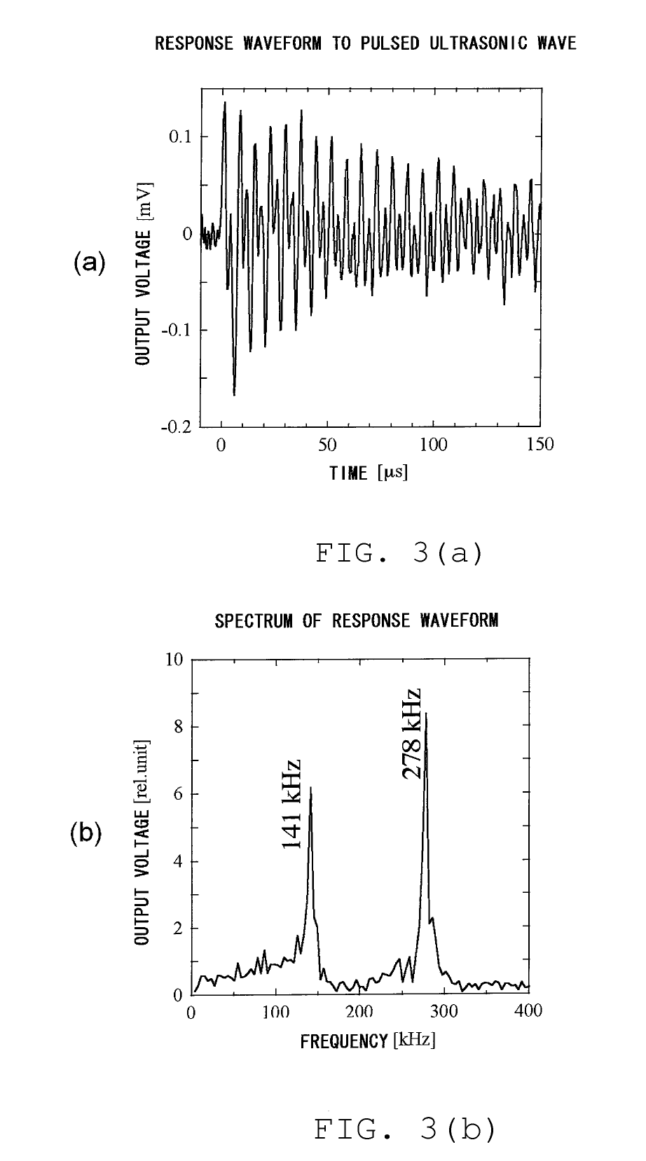

FIG. 3(a) is a diagram showing a response waveform corresponding to a wave motion based on an ultrasonic wave sensed by the first sensing element 102a. FIG. 3(b) is a diagram showing a spectrum of a response waveform which is obtained by the Fourier transform of the waveform of FIG. 3(a). In the waveform diagram of FIG. 3(a), the vertical axis indicates output voltages, and the horizontal axis indicates time. In the spectrum diagram of FIG. 3(b), the vertical axis indicates output voltages, and the horizontal axis indicates frequencies.

The first sensing element 102a corresponds to a resonance sensing element. The first sensing element 102a has sensitivity to a plurality of resonant frequencies. The sensing section 102 senses an ultrasonic wave having a first specific resonant frequency of the frequencies which comes from an object to be sensed, and an ultrasonic wave having a second specific resonant frequency of the frequencies.

For example, resonance occurs in the first sensing element 102a at a specific resonant frequency (e.g., the first resonant frequency (141 kHz) and the second resonant frequency (278 kHz)). The first sensing element 102a receives pulses having a wide frequency spectrum to oscillate at a specific resonant frequency and output an output waveform corresponding to the specific resonant frequency.

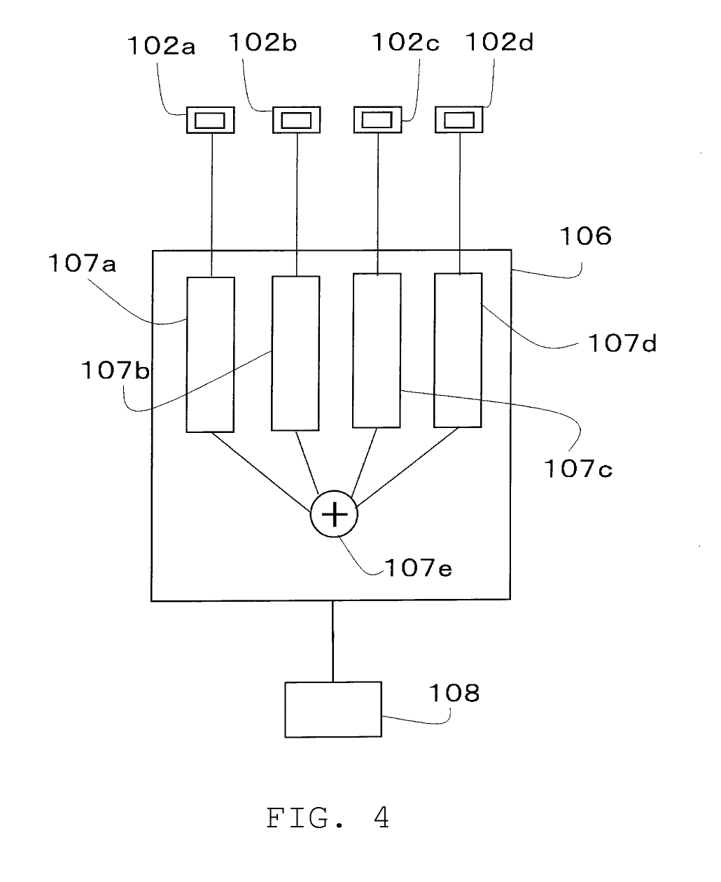

FIG. 4 is a schematic diagram showing the information acquisition section 106. The information acquisition section 106 includes a plurality of variable delay devices (a first variable delay device 107a, a second variable delay device 107b, a third variable delay device 107c, and a fourth variable delay device 107d) and an adder 107e. The information acquisition section 106 acquires, for example, information (first information) about a direction in which a first ultrasonic wave having the first resonant frequency comes, and information (second information) about a direction in which a second ultrasonic wave having the second resonant frequency comes.

The first information contains first direction information and first false information. The second information contains second direction information and second false information. The first direction information indicates a direction in which the first ultrasonic wave comes, and the second direction information indicates a direction in which the second ultrasonic wave comes. If the first and second ultrasonic waves have the same incoming direction, the first direction information is the same as the second direction information. If the first and second ultrasonic waves have different incoming directions, the first direction information is different from the second direction information. The first false information indicates a direction which is not the incoming direction of the first ultrasonic wave, and the second false information indicates a direction which is not the incoming direction of the second ultrasonic wave. At least, the first false information is different from the second false information.

The information acquisition section 106 receives pieces of first output waveform information corresponding to the first resonant frequency from each of the sensing elements, adds these pieces of first output waveform information together, and outputs the addition result (first information) to the determination section 108. A delay pattern corresponding to a scan angle φ is set in each of the variable delay devices. The adder 107e adds a plurality of pieces of input waveform information together, and outputs the addition result.

The information acquisition section 106 also receives pieces of second output waveform information corresponding to the second resonant frequency from each of the sensing elements, adds these pieces of second output waveform information together, and outputs the addition result (second information) to the determination section 108.

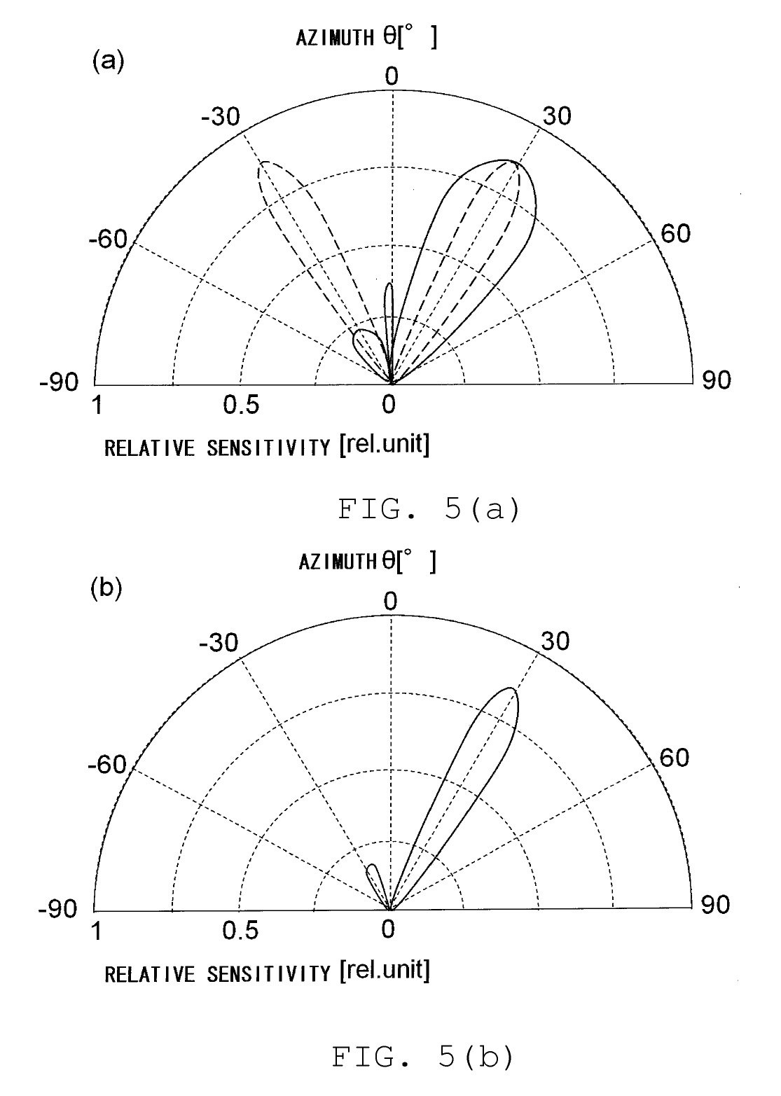

FIG. 5(a) is a chart showing a directional pattern corresponding to the first information and a directional pattern corresponding to the second information. The radial coordinate indicates relative sensitivities, and the angular coordinate indicates azimuths θ. A directional pattern indicated by a solid line corresponds to the first information, and a directional pattern indicated by a dashed line correspond to the second information. In this chart, directional patterns appearing at an azimuth of 30° indicate main lobes corresponding to the first direction information and the second direction information. Directional patterns appearing at other azimuths indicate side lobes corresponding to the first false information and the second false information. Directional patterns appearing at an azimuth of −30° indicate grating lobes. A grating lobe is a side lobe which is equal to or greater than a main lobe. Note that, in the present invention, a frequency corresponding to a directional pattern which does not indicate a grating lobe corresponds to a low frequency, and a frequency corresponding to a directional pattern which indicates a grating lobe corresponds to a high frequency.

The determination section 108 determines the direction of the target 2 based on, for example, the arithmetic product of a value indicating the first information and a value indicating the second information.

By previously performing geometric analysis, the sensing section 102 can select the first and second frequencies so that the information acquisition section 106 acquires the first false information and the second false information different from the first false information. Because the first false information is different from the second false information, a ghost can be reliably reduced by calculation based on the first information and the second information.

FIG. 5(b) is a chart showing a directional pattern corresponding to the arithmetic product of the value indicating the first information and the value indicating the second information. The radial coordinate indicates relative sensitivities, and the angular coordinate indicates azimuths θ. A directional pattern appearing at an azimuth of 30° indicates a main lobe which is sharpened by calculation of the arithmetic product of a value indicating the first direction information and a value indicating the second direction information. At other azimuths, directional patterns substantially disappear by calculation of the arithmetic product of a value of the first false information and a value of the second false information.

As can be seem from the directional pattern shown after calculation of the arithmetic product, a difference between the direction information and the false information becomes more significant, and therefore, a ghost which occurs significantly when only higher frequencies (second frequency) are present is reduced, and a high directivity which is not obtained when only lower frequencies (first frequency) are present is achieved.

Incidentally, in order to obtain a sharper main lobe and reduce a ghost to a further extent, it is effective to additionally apply more wave motions to the arithmetic product. An example will be described in which the arithmetic product of wave motions having a first frequency, a second frequency, and a third frequency is calculated in a linear array having seven elements with an element pitch which is exactly one wavelength of the first frequency f_{H} which is a reference frequency.

Here, the performance of the array is evaluated based on the ratio (hereinafter referred to as a “side lobe level”) of the intensity of a maximum side lobe (including a grating lobe) to the intensity of a main lobe, where an azimuth angle range within which electron scanning is performed, i.e., the “field of view” of the array sensor, is ±60 degrees.

In a measurement using only one frequency (i.e., a wave motion having the first frequency), the side lobe level is as high as 192%. In contrast to this, in a measurement using two frequencies (i.e., a wave motion having the first frequency and a wave motion having the second frequency lower than the first frequency), the side lobe level is reduced to 17.3% by calculation of the arithmetic product, where the second frequency f_{L} is f_{L}=0.57 f_{H}. In a measurement using three frequencies (i.e., a wave motion having the first frequency, a wave motion having the second frequency lower than the first frequency, and a wave motion having the third frequency lower than the second frequency), the side lobe level is reduced to as low as 2.7% by calculation of the arithmetic product, where the second frequency f_{L} is f_{L}=0.74 f_{H}, and the third frequency f_{LL} is f_{LL}=0.42 f_{H}.

Thus, by increasing the number of wave motions which are involved in calculation of the arithmetic product, the side lobe level can be significantly reduced, whereby a ghost is reduced and a main lobe is sharpened to a considerable extent.

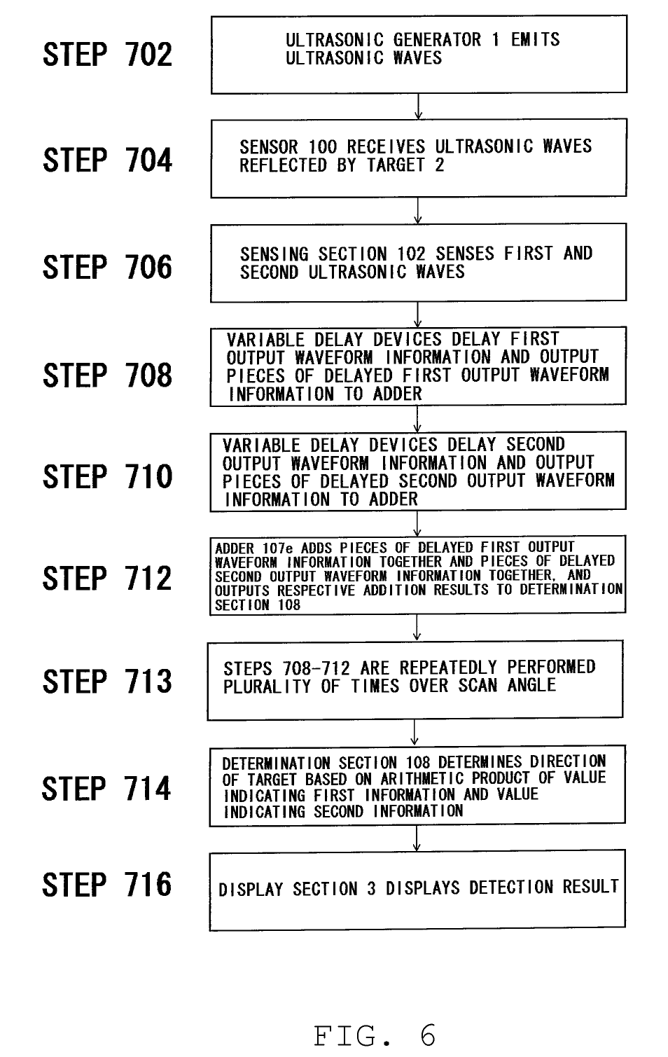

FIG. 6 is a flowchart showing a sensing method using the sensor 100 of the first embodiment of the present invention. The sensing method using the sensor 100 of the first embodiment will be described hereinafter with reference to FIGS. 1, 4, and 6.

Step 702: the ultrasonic generator 1 emits ultrasonic waves. The ultrasonic waves reach the target 2 and are then reflected by the target 2. The ultrasonic waves reflected by the target 2 are incident to the sensor 100 at a predetermined angle relative to a direction perpendicular to a surface of the sensor 100 to which the ultrasonic waves are incident. The predetermined angle (incident angle) may be, for example, 30°.

Step 704: the sensor 100 receives the ultrasonic waves reflected by the target 2.

Step 706: the sensing section 102 senses a first ultrasonic wave having a first one of a plurality of frequencies and a second ultrasonic wave having a second one of the frequencies.

Resonance occurs in each sensing element at a specific resonant frequency (e.g., a first resonant frequency (141 kHz) and a second resonant frequency (278 kHz)). For example, each sensing element receives pulses having a wide frequency spectrum, oscillates at a specific resonant frequency, and outputs output waveform information corresponding to the resonant frequency to each of the variable delay devices. The output waveform information output by each sensing element is signal waveform information containing a time delay of the sensing element.

Step 708: each variable delay device delays the first output waveform information corresponding to the first resonant frequency, and outputs the delayed first output waveform information to the adder 107e.

Functions of the variable delay devices relating to the first output waveform information will be described hereinafter.

The first variable delay device 107a receives the first output waveform information output from the first sensing element 102a, delays the first output waveform information, and outputs the delayed first output waveform information to the adder 107e. The second variable delay device 107b, the third variable delay device 107c, and the fourth variable delay device 107d receive the first output waveform information output from the sensing elements 102b, 102c, and 102d, respectively, delay the first output waveform information, and output the delayed first output waveform information to the adder 107e.

By processing the first output waveform information using the variable delay devices, the phase of the waveform information input to the adder 107e can be aligned.

Step 710: each variable delay device delays the second output waveform information corresponding to the second resonant frequency, and outputs the delayed second output waveform information to the adder 107e.

Functions of the variable delay devices relating to the second output waveform information will be described hereinafter.

The first variable delay device 107a receives the second output waveform information output from the first sensing element 102a, delays the second output waveform information, and outputs the delayed second output waveform information to the adder 107e. The second variable delay device 107b, the third variable delay device 107c, and the fourth variable delay device 107d receive the second output waveform information output from the sensing elements 102b, 102c, and 102d, respectively, delay the second output waveform information, and output the delayed second output waveform information to the adder 107e.

By processing the second output waveform information using the variable delay devices, the phase of the waveform information input to the adder 107e can be aligned.

Step 712: the adder 107e adds the delayed first output waveform information output from the variable delay devices together (in-phase combination), and outputs the addition result (first information) to the determination section 108. The adder 107e also adds the delayed second output waveform information output from the variable delay devices together (in-phase combination), and outputs the addition result (second information) to the determination section 108.

By performing steps 708-712, the information acquisition section 106 acquires the first information about the incoming direction of the first ultrasonic wave and the second information about the incoming direction of the second ultrasonic wave.

Although, in the above example sensing method, step 708 is performed before step 710, the order in which steps 708 and 710 are performed is not particularly limited as long as the delayed first output waveform information is output to the adder 107e in step 708, and the delayed second output waveform information is output to the adder 107e in step 710. For example, steps 708 and 710 may be performed in parallel.

Step 713: steps 708-712 are repeatedly performed a plurality of times over the scan angle (φ). As a result, all information can be acquired over the scanning range.

Step 714: the determination section 108 determines a direction of an object to be sensed, based on the arithmetic product of a value indicating the first information and a value indicating the second information.

Step 716: the display section 3 displays the detection result.

The sensor 100 and sensing method of the first embodiment of the present invention have heretofore been described with reference to FIGS. 1-6.

Although, in the sensor 100 of the first embodiment, the sensing section 102 senses an ultrasonic wave having a specific resonant frequency, an ultrasonic wave to be sensed is not limited to one that has a specific resonant frequency. If the information acquisition section 106 acquires information about the incoming direction of an ultrasonic wave having a first frequency and information about the incoming direction of an ultrasonic wave having a second frequency, the sensing section 102 may include a frequency filter, for example. For example, the frequency filter passes a desired first frequency and a desired second frequency different from the first frequency. The sensing section 102 has sensitivity to the first and second frequencies.

If a frequency suitable for efficient reduction of a ghost and a frequency for providing a highest resolution have been found out by previously performing geometric analysis, the frequency filter can be arbitrarily designed so that the frequencies of ultrasonic waves to be sensed by the sensing sections are set to those frequencies. As a result, a sensor in which a ghost is reduced to a highest extent and a highest resolution is provided can be obtained without any special process, such as frequency exchange etc.

For example, if the first and second frequencies have been found out by previously performing geometric analysis so that information corresponding to a grating lobe is contained only in the second one of the first false information and the second false information, the sensing section 102 can be designed to sense the first and second frequencies of ultrasonic waves. In this case, the first frequency corresponds to a low frequency, and the second frequency corresponds to a high frequency.

For example, by previously performing geometric analysis, the sensing section 102 can select the first and second frequencies so that the first grating lobe indicating a directional pattern corresponding to the first resonant frequency does not appear within the measurement scan range, and the first grating lobe and the second grating lobe indicating a directional pattern corresponding to the second resonant frequency do not overlap.

According to the sensor of the present invention, the sensing section 102 senses at least a first ultrasonic wave having a first one of a plurality of frequencies, and a second ultrasonic wave having a second one of the frequencies, obtains first information about the incoming direction of the first ultrasonic wave and second information about the incoming direction of the second ultrasonic wave, and determines a direction of an object to be sensed, based on at least the first information and the second information. Therefore, a sensor can be obtained in which a ghost which occurs significantly when only a single higher frequency is present can be reduced, and a sharp directivity (high resolution) which cannot be obtained when only a single lower frequency is present can be achieved.

Thus, with the configuration of the sensor of the present invention, by acquiring a plurality of pieces of information using a single sensor, an influence of a grating lobe can be eliminated without narrowing the inter-element spacing. Therefore, the number of elements for achieving the same angular resolution (i.e., for configuring an array having the same diameter) can be significantly reduced. In particular, in a three-dimensional measurement, if elements are arranged in two dimensions, the reduction effect can be improved by the square.

As described in the first embodiment, if the first and second frequencies are selected so that the first false information is different from the second false information, a ghost can be reliably reduced by determining a direction of an object to be sensed, based on the first information and the second information.

As described in the first embodiment, if a direction of an object to be sensed is determined based on the arithmetic product of a value indicating the first information and a value indicating the second information, an influence of a grating lobe can be eliminated, whereby a ghost can be reduced. Note that the arithmetic product can be calculated using a simple calculation circuit, and therefore, a simple and low-cost sensor structure can be constructed.

### Second Embodiment

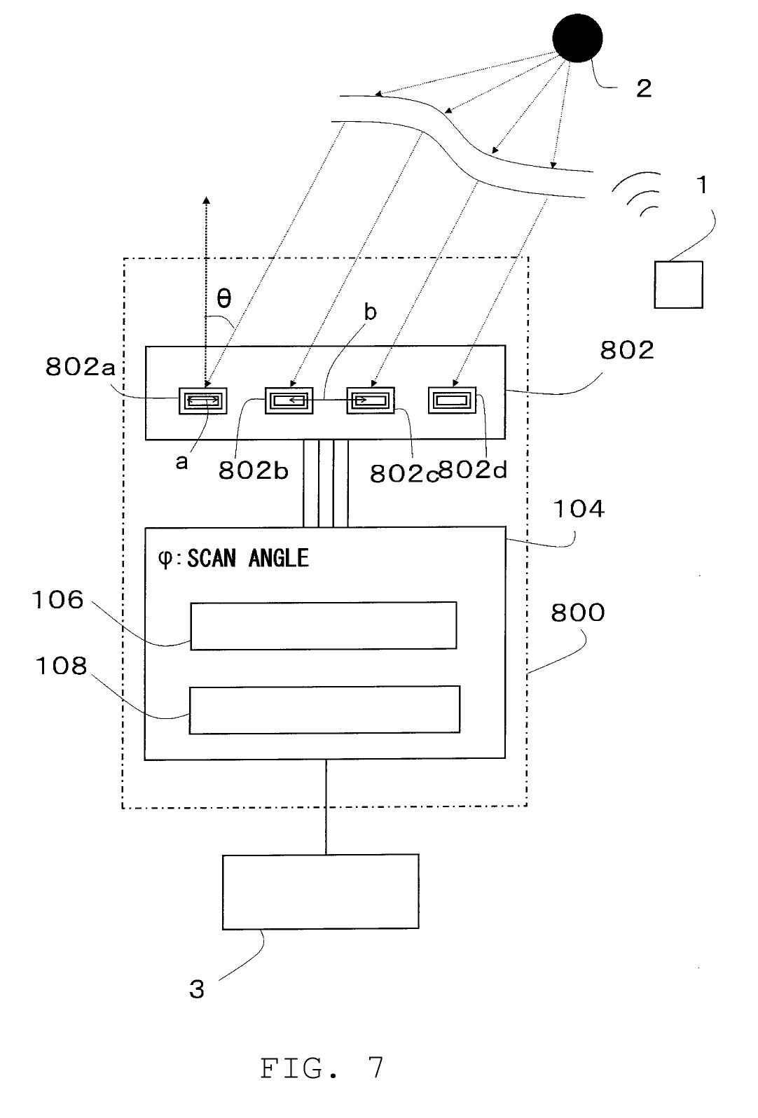

FIG. 7 is a schematic diagram showing a configuration of a sensor 800 according to a second embodiment of the present invention. The sensor 800 includes a sensing section 802 which senses ultrasonic waves having a plurality of frequencies which come from an object to be sensed (target 2), and an information processor 104. The information processor 104 includes an information acquisition section 106 and a determination section 108. The sensing section 802 includes a plurality of sensing elements (a fifth sensing element 802a, a sixth sensing element 802b, a seventh sensing element 802c, and an eighth sensing element 802d). The configuration of the sensor 800 is the same as the configuration of the sensor 100 of the first embodiment, except for the sensing section 802. For example, a piezoelectric diaphragm microsensor functions as each of the sensing elements. In FIG. 7, a length of a diaphragm portion (a diameter of the array) is represented by a “length a,” and an element pitch (inter-element spacing) is represented by a “length b.”

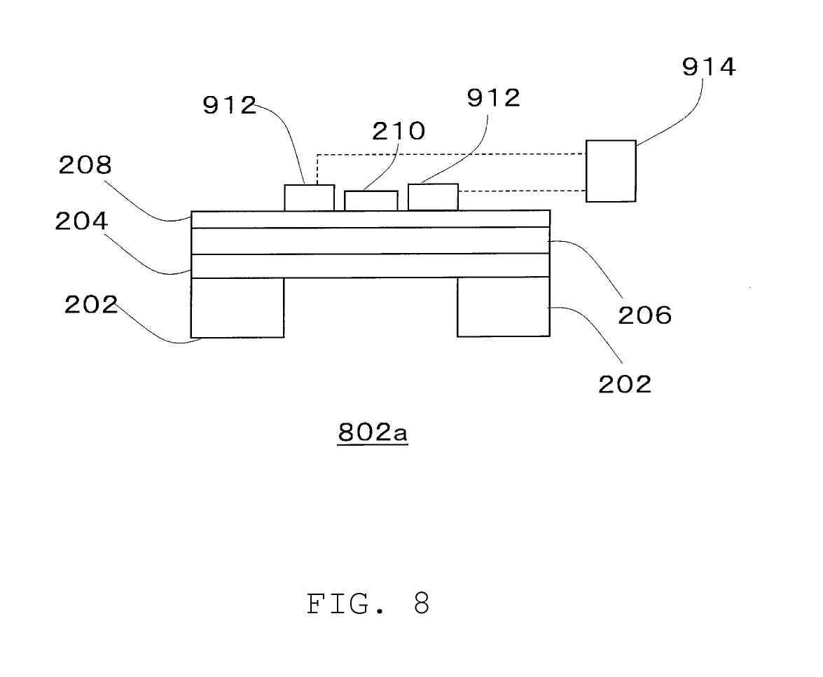

FIG. 8 is a cross-sectional view showing a piezoelectric diaphragm microsensor which is an example of one (the fifth sensing element 802a) of the sensing elements. The fifth sensing element 802a includes a Si substrate 202, a SiO₂ layer 204, a lower electrode layer 206, a piezoelectric layer 208, an upper electrode layer 210, an external electrode 912, and a frequency adjuster 914. The configuration of the fifth sensing element 802a is the same as the configuration of the first sensing element 102a of the first embodiment, except for the external electrode 912 and the frequency adjuster 914.

The external electrode 912 contains Au. The Au electrode functions as, for example, the external electrode 912. The frequency adjuster 914 adjusts the frequency of an ultrasonic wave to be sensed by the fifth sensing element 802a from the first frequency to the second frequency by applying a voltage to the external electrode 912 and thereby causing stress in the diaphragm due to the inverse piezoelectric effect.

The configuration of each of the sixth sensing element 802b, the seventh sensing element 802c, and the eighth sensing element 802d is equivalent to the configuration of the fifth sensing element 802a.

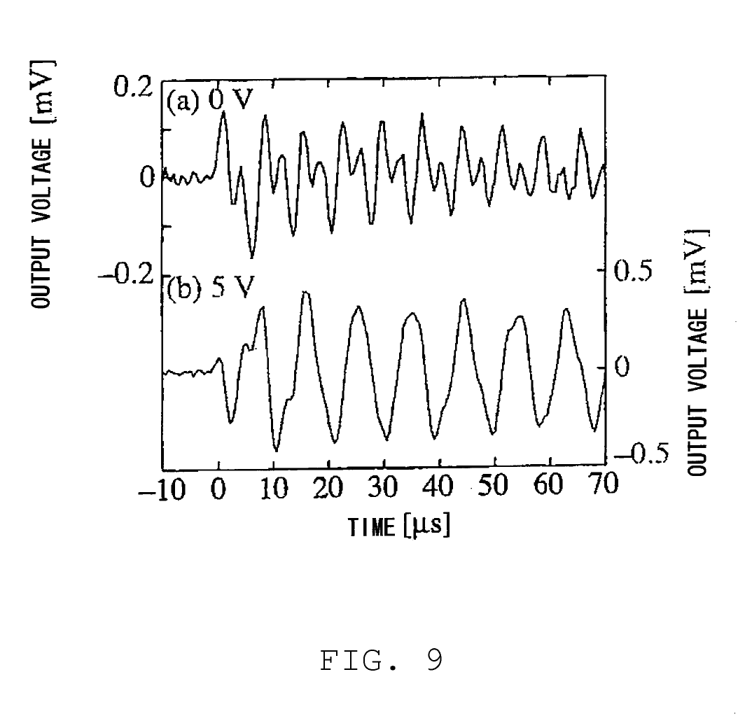

FIG. 9 shows diagrams each showing a response waveform corresponding to a wave motion based on an ultrasonic wave sensed by the fifth sensing element 802a. The vertical axis indicates output voltages, and the horizontal axis indicates time. Of two waveform diagrams shown in FIG. 9, (a) indicates a response waveform which is obtained when a voltage of 0 V is applied to the external electrode 912, and (b) indicates a response waveform which is obtained when a voltage of 5 V is applied to the external electrode 912. The period of the response waveform varies, depending on the applied voltage.

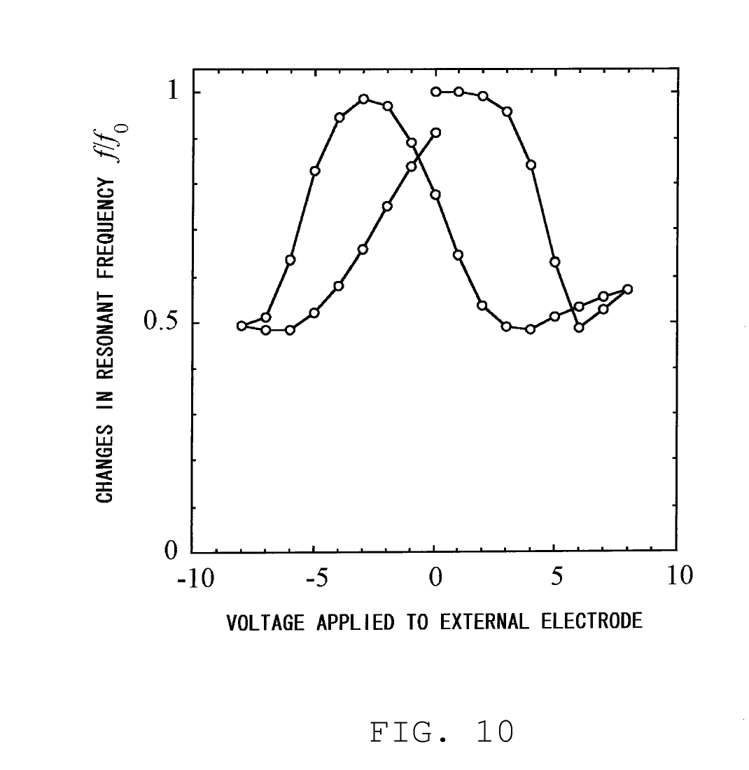

FIG. 10 is a hysteresis diagram showing changes in the resonant frequency of the fifth sensing element 802a with respect to voltages applied to the external electrode 912. The vertical axis indicates changes in the resonant frequency, and the horizontal axis indicates voltages applied to the external electrode.

The resonant frequency of the fifth sensing element 802a varies along a butterfly curve typical of ferroelectric materials, depending on the voltage applied to the external electrode 912. By applying a voltage of 5 V to the external electrode 912, a frequency adjustment width of about 50% can be achieved.

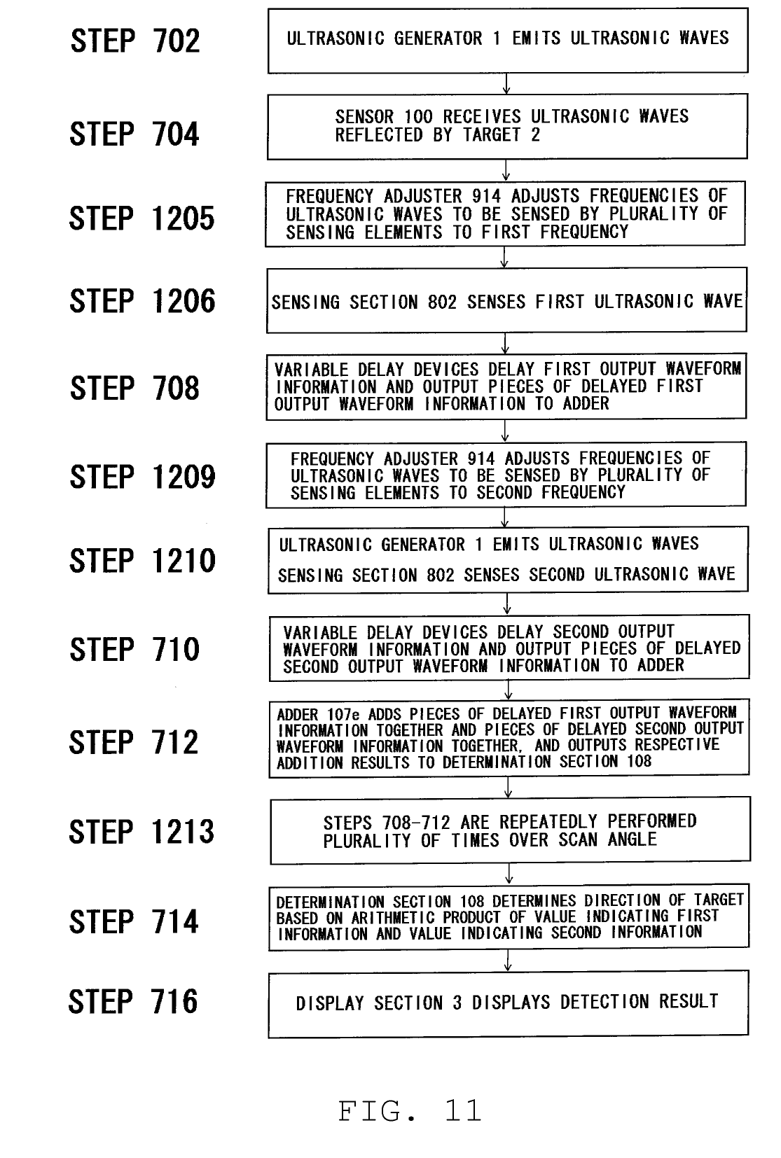

FIG. 11 is a flowchart showing a sensing method using the sensor 800 of the second embodiment of the present invention. The sensing method using the sensor 800 of the second embodiment will be described hereinafter with reference to FIGS. 7, 8, and 11. The steps of the sensing method using the sensor 800 of the second embodiment are the same as those of the sensing method using the sensor 100 of the first embodiment, except for steps 1205, 1206, 1209, 1210, and 1213.

Following steps 702 and 704, steps 1205 and 1206 are performed.

Step 1205: the frequency adjuster 914 adjusts the frequencies of ultrasonic waves to be sensed by the sensing elements to the first frequency.

Step 1206: the sensing section 802 senses the first ultrasonic wave having the first one of a plurality of frequencies.

Resonance occurs in the sensing elements at a specific resonant frequency (e.g., a first resonant frequency (141 kHz)). For example, each sensing element receives pulses having a wide frequency spectrum, oscillates at the specific resonant frequency, and outputs output waveform information corresponding to the resonant frequency to each of the variable delay devices. The output waveform information output by each sensing element is signal waveform information containing a time delay of each of the sensing elements.

Following step 1206, steps 708, 1209, and 1210 are performed.

Step 1209: the frequency adjuster 914 applies a voltage to the external electrode 912 to adjust the frequencies of ultrasonic waves to be sensed by the sensing elements to the second frequency.

Step 1210: the ultrasonic generator 1 generates ultrasonic waves. The sensing section 802 senses the second ultrasonic wave.

Following step 1210, steps 710 and 1213 are performed.

Step 1213: steps 708-712 are repeatedly performed a plurality of times over a scan angle (φ).

Following step 1213, steps 714 and 716 are performed.

The sensor 800 and sensing method of the second embodiment of the present invention have heretofore been described with reference to FIGS. 7-11.

According to the sensor of the present invention, of a plurality of frequencies, at least a first ultrasonic wave having a first frequency and a second ultrasonic wave having a second frequency are sensed to acquire first information about an incoming direction of a first ultrasonic wave and second information about an incoming direction of a second ultrasonic wave. Based on at least the first information and the second information, a direction of an object to be sensed is determined. Therefore, a sensor can be obtained in which a grating lobe-based ghost which occurs significantly when only a single higher frequency is present can be reduced, and a sharp directivity (high resolution) which cannot be obtained when only a single lower frequency is present can be achieved.

Thus, with the configuration of the sensor of the present invention, by acquiring a plurality of pieces of information using a single sensor, an influence of a grating lobe can be eliminated without narrowing the inter-element spacing. Therefore, the number of elements for achieving the same angular resolution (i.e., for configuring an array having the same diameter) can be significantly reduced. In particular, in a three-dimensional measurement, if elements are arranged in two dimensions, the reduction effect can be improved by the square.

Note that the frequency adjuster 914 is not limited to adjustment by applying a voltage to the external electrode 912 as long as the first resonant frequency can be adjusted to a frequency different from the first resonant frequency. For example, the frequency adjuster 914 may adjust the frequencies of ultrasonic waves to be sensed by a plurality of sensing elements from the first frequency to the second frequency by applying external energy, such as heat, magnetic field, light, or the like, to the sensing elements.

According to the configuration of the present invention, if a frequency suitable for efficient reduction of a ghost and a frequency for providing a highest resolution have been found out by previously performing geometric analysis, the frequencies of ultrasonic waves sensed by the sensing section can be arbitrarily adjusted to those frequencies. As a result, a sensor can be obtained in which a ghost is reduced to a highest extent and a highest resolution is provided.

For example, if the first and second frequencies have been found out by previously performing geometric analysis so that information corresponding to a grating lobe is contained only in the second one of the first false information and the second false information, the frequency adjuster 914 can adjust frequencies to be sensed by the sensing section 802 to the first and second frequencies. In this case, the first frequency corresponds to a low frequency, and the second frequency corresponds to a high frequency.

For example, by previously performing geometric analysis, the frequency adjuster 914 can adjust the first and second frequencies sensed by the sensing section 802 so that the first grating lobe indicating a directional pattern corresponding to the first resonant frequency does not appear within the measurement scan range, and the first grating lobe and the second grating lobe indicating a directional pattern corresponding to the second resonant frequency do not overlap.

The sensor and sensing method of the present invention have heretofore been described with reference to FIGS. 1-11.

Although, in the above description, the sensing element is assumed to be a piezoelectric diaphragm (four sides are fixed), the sensing element is not limited to the piezoelectric diaphragm (four sides are fixed) as long as the sensing element can sense wave motions having a plurality of frequencies which come from an object to be sensed. For example, the sensing element may be, for example, of bridge type (two sides are fixed) or cantilever type (one side is fixed).

Although, in the above description, it is assumed that two frequencies of wave motions are sensed by the sensing section, the number of frequencies of wave motions sensed by the sensing section is not limited two and may be two or more. For example, wave motions having three or more frequencies may be sensed within the scope of the present invention. In this case, sensing may be performed using all sensed wave motions having three or more frequencies, or alternatively, sensing may be performed by selecting any two of sensed frequencies. Although, in the above description, one of the two frequencies is a low frequency and the other is a high frequency, both of the two frequencies may be low or high, and in this case, at least one of a higher resolution and ghost reduction can be expected.

Although, in the above description, the determination section 108 calculates the arithmetic product of the value indicating the first information and the value indicating the second information, the present invention is not limited to the arithmetic product. For example, the minimum calculation may be performed. Alternatively, the arithmetic product and the minimum calculation may be combined within the scope of the present invention. For example, if three frequencies are sensed, the arithmetic product of a value indicating the first information and a value indicating the second information may be calculated, and the minimum operation may be performed on the arithmetic product and a value indicating the third information. Note that the minimum calculation means that a minimum value is selected from a plurality of values.

Although, in the above description, the wave motion is mainly assumed to be a wave motion which is based on an ultrasonic wave, the incoming wave motion is not limited to wave motions based on ultrasonic waves as long as the sensing section can sense wave motions having a plurality of frequencies which come from an object to be sensed. For example, the incoming wave motion may be based on an electromagnetic wave (light, infrared, X-ray, etc.).

If the incoming wave motion is based on light, the sensing element may be, for example, a photoelectric element. A light generator (light emitting element) emits light toward an object to be sensed. The light reaches the object to be sensed and is then reflected by the object to be sensed. The light reflected by the object to be sensed is incident to the sensor.

The photoelectric element senses wave motions having a plurality of frequencies which come from the object to be sensed. When the photoelectric element receives light, a current flows in the photoelectric element. The sensor detects a direction of the object to be sensed, based on the current.

The photoelectric element may be, for example, a cadmium sulfide element (CdSe element). By controlling the intensity of light incident to the CdSe element, the resistance value of the CdSe element can be changed, and the resistance value of the CdSe element varies, depending on the brightness. When the ambient is dark, the resistance value of the CdSe element is high, and therefore, substantially no current flows in the CdSe element. When the ambient is light, the resistance of the CdSe element is low, so that a current flows in the CdSe element.

The sensing element may be, for example, a photodiode. When light is incident to the p-n junction of the photodiode, a potential difference occurs, so that a current flows in the photodiode.

### INDUSTRIAL APPLICABILITY

The sensor and sensing method of the present invention are widely applicable to the sensing field (e.g., obstacle sensing (parking, parallel parking, and an autonomous moving robot), and posture sensing (prevention of drowsy driving and monitoring of an individual who needs care)).

### DESCRIPTION OF REFERENCE CHARACTERS

100 SENSOR

102 SENSING SECTION

102a FIRST SENSING ELEMENT

102b SECOND SENSING ELEMENT

102c THIRD SENSING ELEMENT

102d FOURTH SENSING ELEMENT

104 INFORMATION PROCESSOR

106 INFORMATION ACQUISITION SECTION

108 DETERMINATION SECTION

914 FREQUENCY ADJUSTER

1. A sensor for detecting a direction of an object to be sensed, comprising:
a sensing section configured to sense wave motions having a plurality of frequencies which come from the object to be sensed;
an information acquisition section configured to acquire information about incoming directions of the wave motions; and
a determination section configured to determine the direction of the object to be sensed, wherein
the sensing section senses at least a first wave motion having a first one of the plurality of frequencies and a second wave motion having a second one of the plurality of frequencies,
the information acquisition section acquires first incoming direction information about the incoming direction of the first wave motion and first false information indicating a direction different from the incoming direction of the first wave motion, and second incoming direction information about the incoming direction of the second wave motion and second false information indicating a direction different from the incoming direction of the second wave motion, where the first false information is different from the second false information, and
the determination section determines the direction of the object to be sensed, based on the arithmetic product of at least first information including the first incoming direction information and the first false information, and second information including the second incoming direction information and the second false information.

2. (canceled)

3. (canceled)

4. The sensor of claim 1, wherein
the plurality of frequencies include a plurality of resonant frequencies possessed by the sensing section,
the first frequency corresponds to a first one of the plurality of resonant frequencies, and
the second frequency corresponds to a second one of the plurality of resonant frequencies.

5. The sensor of claim 1, further comprising:
a frequency adjuster configured to adjust a frequency of a wave motion to be sensed by the sensing section from the first frequency to the second frequency.

6. A sensing method for detecting a direction of an object to be sensed, comprising:
a sensing step of sensing wave motions having a plurality of frequencies which come from the object to be sensed;
an information acquisition step of acquiring information about incoming directions of the wave motions; and
a determination step of determining the direction of the object to be sensed, wherein
the sensing step is performed by sensing at least a first wave motion having a first one of the plurality of frequencies and a second wave motion having a second one of the plurality of frequencies,
the information acquisition step acquires first incoming direction information about the incoming direction of the first wave motion and first false information indicating a direction different from the incoming direction of the first wave motion, and second incoming direction information about the incoming direction of the second wave motion and second false information indicating a direction different from the incoming direction of the second wave motion, where the first false information is different from the second false information, and
the determination step determines the direction of the object to be sensed, based on the arithmetic product of at least first information including the first incoming direction information and the first false information, and second information including the second incoming direction information and the second false information.
